(19) United States
(12) Patent Application Publication
(10) Pub. No.: US 2021/0264406 A1
(43) Pub. Date: Aug. 26, 2021

(54) METHOD AND SYSTEM FOR FACILITATING SECURE CARD-BASED TRANSACTIONS

(71) Applicant: Mastercard International Incorporated, Purchase, NY (US)

(72) Inventors: Ujjwal Sharma, Mohali (IN); Mrinal Gupta, Alwar (IN); Simran Haathiramani, New Delhi (IN); Nishita Marwaha, Dwarka (IN); Harsh Vardhan Singh, Singrauli (IN); Devrath Satyam, Gurgaon (IN)

(73) Assignee: Mastercard International Incorporated, Purchase, NY (US)

(21) Appl. No.: 17/178,986

(22) Filed: Feb. 18, 2021

(30) Foreign Application Priority Data
Feb. 26, 2020 (IN) 202021008054

(51) Int. Cl. G06Q 20/34; G06K 19/07; G06K 19/073; H01G 11/46

(52) U.S. Cl. CPC G06Q 20/341; G06K 19/0704; H01G 11/46; G06K 19/073; G06K 19/0708

(57) ABSTRACT

A transaction card comprises at least one input button that receives a transactional input provided by a cardholder of the transaction card for initiating a secure card-based transaction. The input button is coupled to an electronic chip which when activated generates an electrical signal based on the transactional input. The electrical signal includes encrypted transactional data associated with the transaction card. A signal transmitter that is coupled to the electronic chip receives the electrical signal from the electronic chip, converts the electrical signal to one or more light pulses, and transmits the one or more light pulses to one of a terminal device or a user device for executing the transaction. The transaction is processed by an issuer of the transaction card based on the encrypted transactional data included in the one or more light pulses.

### CROSS REFERENCE TO RELATED APPLICATIONS

This application claims priority to Indian Application No. 202021008054, filed Feb. 26, 2020, which is incorporated herein by reference in its entirety

### BACKGROUND

### Field of the Disclosure

Various embodiments of the disclosure relate generally to card-based transactions. More particularly, various embodiments of the present disclosure relate to a transaction card, a method, and a system for facilitating a secure transaction.

### Description of the Related Art

In past few decades, technological advancements have led to the development of transaction systems that allow users to perform cashless transactions, such as deposits and withdrawals, credit transfers, purchase payments, and/or the like. Such transaction systems enable cashless transactions by way of various types of transaction cards, such as credit cards, debit cards, pre-paid cards, and/or the like. Typically, a cashless transaction is performed by using a transaction card at a terminal device, such as an Automated Teller Machine (ATM), a Point-of-Sale (POS) device, or an e-commerce platform. While using the transaction card at the ATM or the POS device, a cardholder of the transaction card is required to provide transactional data (e.g., a Personal Identification Number, a password, or the like) for authentication. Subsequently, the terminal device reads transaction card details stored in the transaction card to initiate the transaction. The transaction may be approved or declined based on the authenticity of the transaction card details and the transactional data. Further, for performing the transaction via the e-commerce platform that is accessible on a user device, the cardholder is required to manually provide the transaction card details and the transactional data (e.g., a card verification value or the Personal Identification Number) to the user device.

For a cardholder, transaction card details and transactional data are sensitive and confidential information, compromise of which may lead to fraudulent transactions through the transaction card. The transaction card details and the transactional data may be compromised while the transaction card is being used at an ATM or a POS device. For example, when the cardholder uses the transaction card at the ATM or the POS device, a bystander may discover the transaction card details printed on the transaction card. The bystander may further obtain the transactional data that is manually entered by the cardholder at the ATM or the POS device. In another example, when the cardholder uses the transaction card at the ATM or the POS device, a cloning or skimming device may be used at the ATM or the POS device for fraudulently obtaining the transaction card details. The transaction card details and the transactional data may further get compromised when the transaction card is used at the e-commerce platform for an e-commerce transaction or when the transaction card is stored on-file with the e-commerce platform. For example, a malicious software, running in background on the user device, may intercept the transaction card details and the transactional data provided by the cardholder to the user device for performing the e-commerce transaction.

The compromise of the transaction card details and the transactional data not only causes the cardholder to face financial loss and emotional despair, but also adversely affects other parties (such as an issuer, an acquirer, or a payment network interchange) involved in transaction processing. For example, the issuer, the acquirer, or the payment network interchange may have to bear the cost of processing transaction disputes and replacing compromised transaction cards. Thus, using the transaction card at the terminal device or the e-commerce platform poses multiple data security threats to the transaction card details and the transactional data, which is undesirable.

In light of the foregoing, there is a need for a technical solution that facilitates a seamless card-based transaction while ensuring security of transaction card details and other transactional data.

### SUMMARY

In an embodiment of the present disclosure, a transaction card for facilitating secure card-based transactions is provided. The transaction card comprises at least one input button, an electronic chip, and a signal transmitter. The input button receives a transactional input provided by a cardholder of the transaction card for initiating a transaction. The electronic chip is coupled to the input button, and configured to generate, upon activation, an electrical signal based on the transactional input. The electrical signal includes encrypted transactional data associated with the transaction card. The signal transmitter is coupled to the electronic chip. The signal transmitter is configured to receive the electrical signal from the electronic chip, convert the electrical signal to one or more light pulses, and transmit the one or more light pulses to one of a terminal device or a user device. The one or more light pulses are transmitted to one of the terminal device or the user device for executing the transaction. The transaction is processed by an issuer of the transaction card based on the encrypted transactional data included in the one or more light pulses.

In another embodiment of the present disclosure, a method for facilitating secure card-based transactions is provided. The method includes, receiving, by an electronic chip of a transaction card, upon activation, a transactional input provided by a cardholder of the transaction card for initiating a transaction. At least one input button on the transaction card is used for providing the transactional input. An electrical signal is generated by the electronic chip based on the transactional input. The electrical signal includes encrypted transactional data associated with the transaction card. The electrical signal is converted to one or more light pulses by a signal transmitter of the transaction card. The one or more light pulses are transmitted by the signal transmitter to one of a user device of the cardholder or a terminal device for executing the transaction. The transaction is processed by an issuer of the transaction card based on the encrypted transactional data included in the one or more light pulses.

In another embodiment of the present disclosure, a system for facilitating secure card-based transactions is provided. The system comprises a transaction card and a terminal device. The transaction card comprises at least one input button, an electronic chip, and a signal transmitter. The input button is configured to receive a transactional input provided by a cardholder of the transaction card for initiating a transaction. The electronic chip is coupled to the input button, and configured to generate, upon activation, a first electrical signal based on the transactional input. The first electrical signal includes encrypted transactional data associated with the transaction card. The signal transmitter is coupled to the electronic chip, and configured to receive the first electrical signal from the electronic chip, and convert the first electrical signal to one or more light pulses. The terminal device is configured to receive the one or more light pulses from the transaction card, and convert the one or more light pulses to a second electrical signal that includes the encrypted transactional data required for processing the transaction. The transaction is processed based on the encrypted transactional data.

### BRIEF DESCRIPTION OF DRAWINGS

The accompanying drawings illustrate the various embodiments of systems, methods, and other aspects of the disclosure. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present disclosure are illustrated by way of example, and not limited by the appended figures, in which like references indicate similar elements:

FIG. 1 is a block diagram that illustrates an exemplary environment for facilitating secure card-based transactions, in accordance with an exemplary embodiment of the present disclosure;

FIG. 2 is a schematic diagram that illustrates a transaction card of FIG. 1 for facilitating a secure card-based transaction, in accordance with an exemplary embodiment of the present disclosure;

FIGS. 3A, 3B, 3C, and 3D, collectively represent a process flow diagram that illustrates an exemplary scenario for facilitating a secure card-based transaction at a terminal device of FIG. 1 using the transaction card of FIGS. 1 and 2, in accordance with an exemplary embodiment of the present disclosure;

FIG. 4 is a schematic diagram that illustrates an exemplary scenario for conducting a card-based transaction using the transaction card of FIGS. 1 and 2 at the terminal device of FIG. 1, in accordance with an exemplary embodiment of the present disclosure;

FIGS. 5A, 5B, 5C, and 5D, collectively represent a process flow diagram that illustrates an exemplary scenario for facilitating a secure card-based transaction using the transaction card of FIGS. 1 and 2 at an e-commerce platform accessed on a user device of FIG. 1, in accordance with an exemplary embodiment of the present disclosure;

FIG. 6 is a schematic diagram that illustrates an exemplary scenario for conducting a card-based transaction using the transaction card of FIGS. 1 and 2 at an e-commerce platform accessed through the user device of FIG. 1, in accordance with an exemplary embodiment of the present disclosure;

FIG. 7 is a block diagram that illustrates an issuer server of FIG. 1, in accordance with an exemplary embodiment of the present disclosure;

FIG. 8 is a block diagram that illustrates a system architecture of a computer system, in accordance with an exemplary embodiment of the present disclosure;

FIG. 9 is a flow chart that illustrates a method for facilitating a secure card-based transaction using the transaction card of FIGS. 1 and 2, in accordance with an exemplary embodiment of the present disclosure;

FIG. 10 is a flow chart that illustrates a method for facilitating a secure card-based transaction at the terminal device of FIG. 1, in accordance with an exemplary embodiment of the present disclosure;

FIG. 11 is a flow chart that illustrates a method for facilitating a secure card-based transaction by the issuer server of FIG. 1, in accordance with an exemplary embodiment of the present disclosure; and

FIG. 12 is a high-level flow chart that illustrates a method for facilitating a secure card-based transaction, in accordance with an exemplary embodiment of the present disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the present disclosure.

### DETAILED DESCRIPTION OF EMBODIMENTS

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### Overview

In a card-based transaction, a transaction card is used at an Automated Teller Machine (ATM) or a user device for communicating transaction card details to various transacting parties (such as merchants, acquirers, payment networks, and issuers) over a communication network. Communication of such transaction card details is vulnerable to security attacks and data thefts, which may result in misuse of the transaction card details. Thus, causing financial loss and distress to a cardholder of the transaction card and other transacting parties, which is undesirable.

Various embodiments of the present disclosure provide a transaction card, a method, and a system that solve the abovementioned problem by providing adequate security measures for protecting the transaction card details from attacks and theft during a transaction. Transaction card details, such as a card number, a card verification value (CVV), and an expiry date are not mentioned on the transaction card. Thus, a bystander is prevented from obtaining the transaction card details by merely looking at the transaction card. The transaction card includes an electronic chip, a signal transmitter, and one or more input buttons. The transaction card further includes a powering device that powers the electronic chip and the signal transmitter. The electronic chip is activated when a cardholder of the transaction card provides an activation input to the transaction card. The activation input is provided using the one or more input buttons on the transaction card. Upon activation, the electronic chip accepts a transactional input provided by the cardholder using the one or more input buttons. Based on the transactional input, the electronic chip generates a first electrical signal that includes encrypted transactional data (e.g., a Personal Identification Number or the CVV) associated with the transaction card. The first electrical signal is communicated to the signal transmitter that is coupled to the electronic chip. The signal transmitter converts the first electrical signal to one or more light pulses and communicates the encrypted transactional data in form of the one or more light pulses to one of a terminal device or a user device. A signal receiver in the terminal device or the user device receives the one or more light pulses and converts the one or more light pulses to a second electrical signal. The terminal device or the user device then communicates the second electrical signal to an issuer of the transaction card for processing the transaction.

Thus, the present disclosure provides a solution for facilitating a secure transaction, and enables seamless and secure transmission of transaction card details and transactional data among the transacting parties.

### Terms Description in Addition to Plain and Dictionary Meaning

Transaction is an exchange of funds between two or more parties. For example, the transaction may include transferring a transaction amount from a user account to a merchant account, when a user makes a purchase from a merchant. In another example, the transaction may include dispensing cash, by an ATM, equivalent to a transaction amount debited from the user account of the user based on a request from the user. The transaction is performed at one of a terminal device or a user device. Furthermore, the transaction also includes an inquiry, or any other operation that is performed by using a transaction card at any one of the terminal device or the user device.

A cardholder of a transaction card is an owner of the transaction card who is authorized to use the transaction card at any one of a terminal device or a user device for initiating transactions.

Transaction card refers to a payment device, such as a debit card, a credit card, a prepaid card, a promotional card, a contactless card, and/or any other device, that allows a cardholder to perform electronic transactions, such as deposits and withdrawals, credit transfers, purchase payments, and the like. The transaction card includes a transaction card memory, at least one input button, electronic circuitry (e.g., an electronic chip), and signal transmitter. The transaction card is issued to the cardholder by an issuer.

Input button refers to an input means present on a transaction card. The input button is operable by a cardholder of the transaction card for providing a transactional input to the transaction card. The input button is associated with specific transactional data (for example, a Personal Identification Number, PIN). The input button, when operated, completes an electronic circuit for the transactional data (for example, the PIN). Completion of the electronic circuit causes generation of an electrical signal including the transactional data in an encrypted form. Examples of the input button include pressure button, push button, touch-sensitive button, and/or the like.

Transactional input refers to an input provided by a cardholder of a transaction card for initiating a transaction at one of a terminal device or a user device. The transactional input is provided by the cardholder via input buttons on the transaction card. In one example, pressing one or more input buttons on the transaction card refers the transactional input.

Transactional data refers to information that is associated with a transaction card and allows for initiation of a transaction using the transaction card. Examples of the transactional data may include, a PIN, a CVV, a password, a security number, and/or the like.

Transaction card memory is a memory unit (e.g., a data storage device) of a transaction card that stores transaction card details. The transaction card memory may be a magnetic stripe or a Europay, Mastercard and Visa (EMV) chip. Further, the transaction card memory is readable by a terminal device.

An electronic chip refers to electronic circuitry (e.g., conductive traces and a microcontroller) present on a transaction card. The electronic chip, upon receiving a transactional input, generates an electrical signal including encrypted transactional data that corresponds to the transactional input. The electronic chip runs on power provided by a powering device and is coupled to one or more input buttons that are used for providing the transactional input.

An electrical signal refers to a signal generated by an electronic chip on a transaction card in response to a transactional input. The electrical signal includes encrypted transactional data associated with the transaction card. The electrical signal, thus, corresponds to a medium for communicating the encrypted transactional data from a source i.e., the electronic chip to a destination i.e., a signal transmitter.

A signal transmitter refers to an electronic device that is configured to convert an electrical signal to one or more light pulses (e.g., optical pulses). The signal transmitter is configured to transmit the one or more light pulses to a signal receiver of any one of a terminal device or a user device. The signal transmitter operates on power drawn from a powering device. Examples of the signal transmitter include, but are not limited to, Infrared (IR) signal transmitter, visible light transmitter, and the like.

One or more light pulses are optical signals (such as, infrared pulses) that store and transmit data (e.g., transactional data) from a signal transmitter to a signal receiver.

Powering device is an electronic or electrochemical device that stores electric charge and provides power to an electronic chip and a signal transmitter of a transaction card. Examples of the powering device include a capacitor, a battery, a Graphene Oxide (GO) based supercapacitor (SC), a Graphene Polymer sheet SC, and/or the like.

A terminal device is an electronic device that enables a cardholder of a transaction card to perform a transaction. Examples of the terminal device include an ATM, a POS device, a mobile POS (MPOS) device, a Point-of-Interaction (POI) device, a Point-of-Purchase (POP) device, a bunch note acceptor, a currency recycler, or the like. The terminal device may be coupled to (or comprise) a signal receiver that is configured to receive one or more light pulses from a signal transmitter of the transaction card. The terminal device may be associated with a server arrangement that is configured to process the transaction.

A user device is an electronic device that enables a user to access a merchant website and perform a transaction using a transaction card. The user device includes a signal receiver that receives one or more light pulses from the transaction card and converts the one or more light pulses to a desired form for transmission. Examples of the user device includes a mobile phone, a computer, a laptop, a smartphone, a tablet, a phablet, and/or the like.

A signal receiver refers to an electronic device that is configured to receive one or more light pulses transmitted by a signal transmitter. The signal receiver may be a part of a terminal device or a user device. Alternatively, the signal receiver may be coupled to a terminal device or a user device. Further, the signal receiver converts the one or more light pulses to an electrical signal. Examples of the signal receiver include IR signal receiver, visible light receiver, and/or the like.

Issuer is a financial institution which establishes and maintains user accounts of several users. The issuer authorizes and processes transactions based upon transaction card details received in a transaction request.

Activation input refers to an input provided by a cardholder of a transaction card for activating an electronic chip of the transaction card. When the cardholder provides the activation input, the electronic chip receives an activation code that activates the electronic chip. The activation code may be a numeric code, an alphanumeric code, an alphabetic code, a mobile gesture, an input command, or the like. In one example, the activation input may be waving the transaction card in a specific manner.

A server arrangement is a physical or cloud data processing system on which a server program runs. The server arrangement may be implemented as hardware or software, or a combination thereof. The server arrangement may correspond to one of a payment network server, an issuer server, an acquirer server, or a merchant server. The server arrangement executes various programs required for processing a transaction.

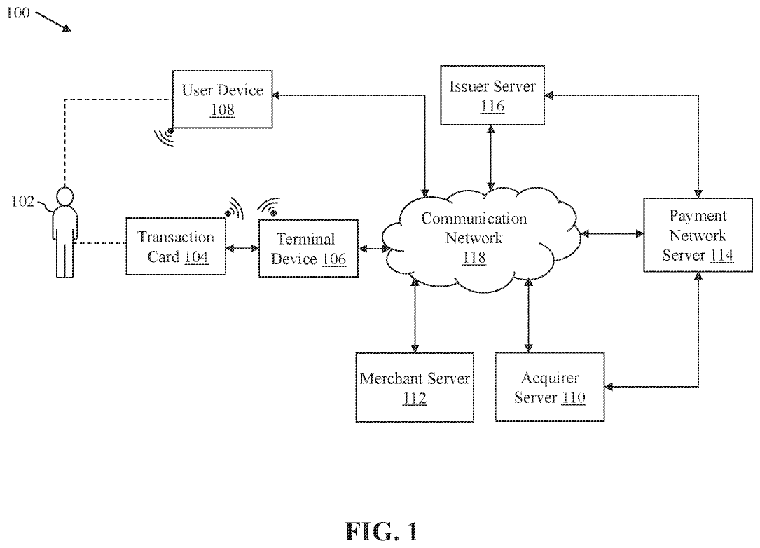

FIG. 1 is a block diagram that illustrates an exemplary environment 100 for facilitating secure card-based transactions, in accordance with an exemplary embodiment of the present disclosure. The environment 100 includes a cardholder 102, a transaction card 104, a terminal device 106, a user device 108, an acquirer server 110, a merchant server 112, a payment network server 114, and an issuer server 116. The terminal device 106, the user device 108, the acquirer server 110, the merchant server 112, the payment network server 114, and the issuer server 116 may communicate with each other by way of a communication network 118 or through separate communication networks established therebetween.

The cardholder 102 is an individual, who owns the transaction card 104. The transaction card 104 is associated with a financial account of the cardholder 102. Examples of the transaction card 104 may include, but are not limited to, a debit card, a credit card, or a prepaid card. The cardholder 102 uses the transaction card 104 for initiating a card-based transaction. Hereinafter, the terms “transaction” and “card-based transaction” are used interchangeably. The cardholder 102 may initiate the transaction by using the transaction card 104 at any one of the terminal device 106 or the user device 108.

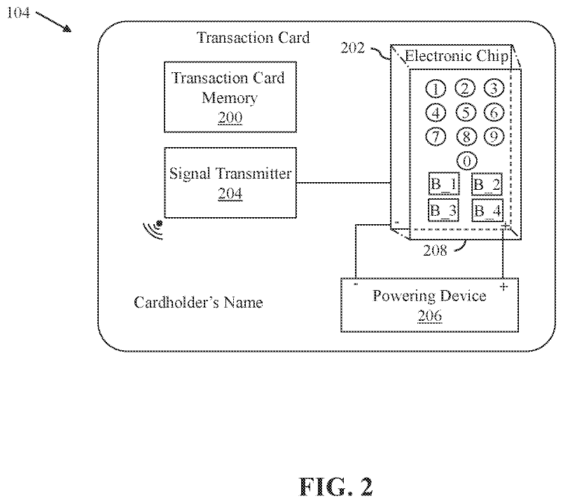

The transaction card 104 is a physical payment card associated with the financial account of the cardholder 102. The transaction card 104, when used at any one of the terminal device 106 or the user device 108, initiates a transaction. The transaction card 104 includes suitable logic, circuitry, interface, and/or code, executable by the circuitry, for initiating the transaction at the terminal device 106 and/or the user device 108. The transaction card 104 stores transaction card details that are communicated to the terminal device 106 or the user device 108 for initiating the transaction. The transaction card 104 may have a plastic body and may not have the transaction card details printed thereon. In one embodiment, only a name of the cardholder 102 may be printed on the transaction card 104 for the cardholder 102 to identify the transaction card 104. The transaction card 104 is readable by the terminal device 106 for obtaining the transaction card details. Further, based on a transactional input provided by the cardholder 102 to the transaction card 104, transactional data and/or any additional data required for initiating the transaction are transmitted, in an encrypted format, from the transaction card 104 to the terminal device 106. The transactional data and/or any other additional data may be transmitted by way of one or more light pulses emitted by the transaction card 104. Various components of the transaction card 104 and their functionalities are described later in FIG. 2.

The terminal device 106 is an electronic device that includes suitable logic, circuitry, interface, and/or code, executable by the circuitry, for facilitating the transaction initiated using the transaction card 104. In one example, the terminal device 106 may be a Point-of-Sale (POS) device that is associated with a first merchant. In such a scenario, the terminal device 106 allows the cardholder 102 to perform transactions using the transaction card 104 for purchasing products and/or services from the first merchant. In another example, the terminal device 106 may be an Automated Teller Machine (ATM) that allows the cardholder 102 to access banking services (e.g., cash withdrawals, cash deposits, balance inquiry, and the like) offered by the issuer server 116 or the acquirer server 110 associated with the terminal device 106. Other examples of the terminal device 106 may include, but are not limited to, a Point-of-Purchase (POP) device, a Point-of-Interaction (POI) device, a currency recycler, a bunch note acceptor, or the like. The terminal device 106 may communicate with the transaction card 104 in a contactless manner or by way of a contact established therebetween.

The user device 108 is a computing device that allows the cardholder 102 to access an e-commerce platform, for example, an e-commerce website or an e-commerce mobile application. Additionally, the cardholder 102 may use the user device 108 to save the transaction card 104 on file with the first merchant and initiate a transaction for making a purchase through the e-commerce platform. Examples of the user device 108 include, but are not limited to, a mobile phone, a computer, a laptop, a smartphone, a tablet, and a phablet. The user device 108 communicates with the transaction card 104 wirelessly, i.e., in a contactless manner.

The acquirer server 110 is a server arrangement which includes suitable logic, circuitry, interface, and/or code, executable by the circuitry, for processing transactions initiated at the terminal device 106. The acquirer server 110 is operated by an acquirer associated with the terminal device 106. The acquirer server 110 further communicates with the payment network server 114 and the issuer server 116 for processing the transactions.

The merchant server 112 is a server arrangement which includes suitable logic, circuitry, interface, and/or code, executable by the circuitry, for processing various transactions. The merchant server 112 is configured to manage and host the e-commerce platform, and process the transactions that are initiated for purchases made at the e-commerce platform. The merchant server 112 communicates with the acquirer server 110, the payment network server 114, and the issuer server 116 for processing the transactions.

The payment network server 114 is a server arrangement which includes suitable logic, circuitry, interface, and/or code, executable by the circuitry, for processing transactions that are performed using the transaction card 104. The payment network server 114 is operated by a payment network (i.e., a payment interchange). The payment network server 114 represents an intermediate entity between the issuer server 116 and the acquirer server 110 or the merchant server 112 for processing the transactions.

The issuer server 116 is a server arrangement which includes suitable logic, circuitry, interface, and/or code, executable by the circuitry, for processing various transactions. The issuer server 116 is operated by an issuer of the transaction card 104. The issuer may be a financial institution that manages one or more financial accounts of the cardholder 102 and other users. The issuer server 116 receives a transaction request for a transaction initiated by way of the transaction card 104. The transaction request may include transaction card details and transactional data associated with the transaction card. The issuer server 116 processes the transaction based on the transaction card details and the transactional data included in the transaction request. The issuer server 116 processes the transaction by approving or declining the transaction. The issuer server 116 may further credit, debit and modify the financial account of the cardholder 102 based on the processing of the transaction. Methods for processing the transactions via the issuer server 116 will be apparent to persons having skill in the art and may include processing a transaction via the traditional four-party system or three-party system.

Examples of the acquirer server 110, the merchant server 112, the payment network server 114, and the issuer server 116 may include, but are not limited to, computers, laptops, mini-computers, mainframe computers, any non-transient and tangible machines that may execute a machine-readable code, cloud-based servers, distributed server networks, a network of computer systems, or a combination thereof.

The communication network 118 is a medium through which content and messages are transmitted between the terminal device 106, the user device 108, the acquirer server 110, the merchant server 112, the payment network server 114, and/or the issuer server 116. Examples of the communication network 118 include, but are not limited to, a Wi-Fi network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the environment 100 may connect to the communication network 118 in accordance with various wired and wireless communication protocols, such as Transmission Control Protocol and Internet Protocol (TCP/IP), User Datagram Protocol (UDP), Long Term Evolution (LTE) communication protocols, or any combination thereof.

FIG. 2 is a schematic diagram that illustrates the transaction card 104 for facilitating a secure card-based transaction, in accordance with an exemplary embodiment of the present disclosure. The transaction card 104 comprises a transaction card memory 200, an electronic chip 202, a signal transmitter 204, a powering device 206, and a keypad 208 including input buttons 0-9, B_1, B_2, B_3, and B_4.

The transaction card memory 200 is a data storage device configured to store the transaction card details of the transaction card 104. The transaction card details may include a card number, an expiry date, a name of the cardholder 102, or the like. Examples of the transaction card memory 200 includes, but are not limited to, an Europay, Mastercard and Visa (EMV) chip and a magnetic stripe. The transaction card memory 200 is readable by the terminal device 106 when the transaction card 104 is used at the terminal device 106. Further, the transaction card memory 200 stores the transaction card details in an encrypted format for enhancing data security. For example, the transaction card details stored in the transaction card memory 200 may be hashed into multi-byte binary codes. In another example, the transaction card details may be encrypted using Public-Private Key Encryption Technique. Encrypting the transaction card details makes the transaction card details obscure and useless for a third party that is not involved in the transaction. It will be apparent to a person of ordinary skill in the art that the transaction card details may be encrypted by using other encryption techniques that are known in the art, without deviating from the scope of the disclosure.

The keypad 208 includes the input buttons 0-9, B_1, B_2, B_3, and B_4. The input buttons 0-9, B_1, B_2, B_3, and B_4 are operable by the cardholder 102 for providing various transactional inputs. In one embodiment, the input buttons 0-9, B_1, B_2, B_3, and B_4 are further operable by the cardholder 102 for providing an activation input. Examples of the input buttons 0-9, B_1, B_2, B_3, and B_4 include, but are not limited to, pressure buttons, push buttons, and/or touch buttons. The cardholder 102 may provide different transactional inputs and the activation input by operating (e.g., pressing) different combinations of the input buttons 0-9, B_1, B_2, B_3, and B_4. For example, to provide the activation input, the cardholder 102 may press the input buttons 0, 1, 2, and 5, sequentially. In another example, to provide first through fourth transactional inputs, the cardholder 102 may press the input buttons B_1, B_2, B_3, and B_4, respectively. Thus, pressing the input buttons B_1, B_2, B_3, and B_4 correspond to providing the first through fourth transactional inputs, respectively.

In one embodiment, each input button 0-9, B_1, B_2, B_3, and B_4 or a combination of the input buttons 0-9, B_1, B_2, B_3, and B_4 may be assigned to different transactional data. Transactional data refers to information that is required for processing a transaction initiated using the transaction card 104. Examples of different transactional data may include a Personal Identification Number (PIN) of the transaction card 104, a Card Verification Value (CVV) of the transaction card 104, a Card Verification Code (CVC) of the transaction card 104, an expiry/valid thru date of the transaction card 104, a card number of the transaction card 104, a cardholder's name of the transaction card 104, or the like. The input buttons 0-9, B_1, B_2, B_3, and B_4 may be assigned to the transactional data by the issuer of the transaction card 104. In another embodiment, the input buttons 0-9, B_1, B_2, B_3, and B_4 may be assigned to the transactional data by the issuer of the transaction card 104 and may be personalized by the cardholder 102 with an assistance from the issuer. For the sake of ongoing description, it is assumed that the input button B_1 is assigned to the PIN of the transaction card 104, the input button B_2 is assigned to the card number of the transaction card 104, the input button B_3 is assigned to the CVV of the transaction card 104, and the input button B_4 is assigned to the expiry date of the transaction card 104. In other words, the first through fourth transactional inputs are associated with the PIN, the card number, the CVV, and the expiry date, respectively, of the transaction card 104.

In one example, the keypad 208 including the input buttons 0-9, B_1, B_2, B_3, and B_4 may be a membrane keypad that consists of three layers: a top layer with number or a digit label printed on it, a space layer, and a back layer that features conductive stripes. When the cardholder 102 operates one of the input buttons 0-9, B_1, B_2, B_3, and B_4, the upper layer and the bottom layer of the operated input button come in contact with each other, thus, completing a circuit corresponding to the operated input button. In another example, the keypad 208 including the input buttons 0-9, B_1, B_2, B_3, and B_4 may be a capacitive keypad. Capacitive keypads use capacitance technology that registers an input when the cardholder 102 operates the input buttons 0-9, B_1, B_2, B_3, and B_4. When the cardholder 102 presses any input button 0-9, B_1, B_2, B_3, and B_4, capacitance of the capacitor pads changes to indicate that an input is provided. It will be apparent to a person of ordinary skill in the art that the scope of implementing the keypad 208 is not limited to the abovementioned examples, and the keypad 208 may have other implementations as known in the art.

The electronic chip 202 includes electronic circuitry (e.g., a microcontroller and conductive traces or stripes) that facilitates the communication of encrypted transactional data associated with the transaction card 104 to the terminal device 106 or the user device 108, for initiating a transaction. The electronic chip 202 may be embedded in the plastic body of the transaction card 104. The electronic chip 202 is connected to the input buttons 0-9, B_1, B_2, B_3, and B_4 and the signal transmitter 204. In one example, the keypad 208 including the input buttons 0-9, B_1, B_2, B_3, and B_4 may be placed over the electronic chip 202, such that when any of the input buttons 0-9, B_1, B_2, B_3, and B_4 is pressed, a circuit on the electronic chip 202 corresponding to the pressed input button gets completed.

When a transactional input (e.g., the first through fourth transactional inputs) is provided by the cardholder 102 by pressing one or more input buttons 0-9, B_1, B_2, B_3, and B_4, the electronic chip 202 generates a first electrical signal that includes encrypted transactional data corresponding to the provided transactional input. The first electrical signal may be a multi-byte binary data that represents encrypted transactional data corresponding the transactional input. For example, when the cardholder 102 provides the first transactional input for initiating the transaction by pressing the input button B_1, assigned to the PIN of the transaction card 104, the electronic chip 202 generates the first electrical signal that includes encrypted PIN of the transaction card 104. In one example, the first electrical signal may include the PIN that is hashed into multi-byte binary code. Likewise, when the cardholder 102 provides other transactional inputs by pressing other input buttons 0-9, B_2, B_3, and B_4, the electronic chip 202 generates the first electrical signal that includes encrypted transactional data corresponding to the provided transactional inputs. The electronic chip 202 then provides the generated first electrical signal to the signal transmitter 204.

The electronic chip 202 is powered by the powering device 206 and activated based on an activation code. The activation code may be provided to the electronic chip 202 by way of the activation input. In one embodiment, the activation code may be a numeric code, for example ‘0125’. In such a scenario, the activation input corresponds to pressing of those input buttons 0-9, B_1, B_2, B_3, and B_4 that represent the numeric digits ‘0’, ‘1’, ‘2’, and ‘5’. For example, the input buttons 0, 1, 2, and 5 on the keypad 208 may represent the numeric digits ‘0’, ‘1’, ‘2’, and ‘5’, respectively. Thus, the cardholder 102 presses the input buttons 0, 1, 2, and 5, sequentially, to provide the activation code ‘0125’ to the electronic chip 202 for activation. In another embodiment, when the transaction card 104 is communicatively coupled to the user device 108, the cardholder 102 may press numeric digits ‘0’, ‘1’, ‘2’, and ‘5’, sequentially, on the user device 108 for providing the activation code to the electronic chip 202. In another embodiment, the activation code may be a specific motion gesture, for example, moving the transaction card 104 in a chopping motion. In such a scenario, the activation input corresponds to moving the transaction card 104 in the chopping motion. For example, the cardholder 102 may move the transaction card 104 in the chopping motion to activate the electronic chip 202. Prior to powering up and activation, the electronic chip 202 is not operational and may not register any transactional input provided by the cardholder 102 using the input buttons 0-9, B_1, B_2, B_3, and B_4.

The signal transmitter 204 is a specialized electronic device that is configured to receive the first electrical signal from the electronic chip 202 and convert the first electrical signal to one or more light pulses. Thus, the light pulses include the encrypted transactional data that was included in the first electrical signal. In other words, the light pulses generated by the signal transmitter 204 may be a sequence of multiple light pulses representing the encrypted transactional data. In one example, the signal transmitter 204 may include a transducer that is configured to convert the first electrical signal to light pulses.

The signal transmitter 204 communicates the light pulses to one of the terminal device 106 or the user device 108 for executing the transaction. The signal transmitter 204 should be in a communication range of the terminal device 106 or the user device 108 for transmitting the light pulses. In one embodiment, for transmitting the light pulses, the transaction card 104 should be within a threshold distance of the terminal device 106 or the user device 108. Examples of the threshold distance may include, but are not limited to 5 cm, 10 cm, 15 cm, and so forth. The threshold distance may be a distance within which the signal transmitter 204 is capable of transmitting the light pulses to the terminal device 106 or the user device 108. In other words, the threshold distance may be a distance within which any one of the terminal device 106 or the user device 108 may receive the light pulses transmitted by the signal transmitter 204.

In one example, the signal transmitter 204 is an IR signal transmitter that generates IR light pulses based on the received first electrical signal and adheres to properties of IR communication. The signal transmitter 204 may generate the IR light pulses having a wavelength ranging from 700 nanometers (nm) to 1 millimeter (mm). In another example, the signal transmitter 204 is an RF transmitter that generates RF pulses based on the received first electrical signal and adheres to properties of RF communication. In another example, the signal transmitter 204 is an optical transmitter that generates optical pulses based on the received first electrical signal and adheres to properties of optical communication. In another example, the signal transmitter 204 is a visible light transmitter that generates visible light pulses based on the received first electrical signal and adheres to properties of visible light communication.

The powering device 206 is an electronic device that is configured to power the electronic chip 202 and the signal transmitter 204. The powering device 206 is connected to the electronic chip 202 such that a positive terminal of the powering device 206 is aligned with and connected to a positive terminal of the electronic chip 202 and a negative terminal of the powering device 206 is aligned with and connected to a negative terminal of the electronic chip 202. In one embodiment, the powering device 206 is detachable from the transaction card 104. Thus, the powering device 206 may be detached from the transaction card 104 when the cardholder 102 does not require to use the transaction card 104 and wants to depower the transaction card 104. In one embodiment, the powering device 206 is rechargeable by way of a charge producing device as is known by those of skill in the art. The powering device 206 may or may not be required to be detached from the transaction card 104 for recharging.

In one embodiment, the powering device 206 may be a rechargeable Graphene Oxide (GO) based supercapacitor (SC). A SC is a high-capacity capacitor that is optimized to have a significantly high capacitance value. In such a scenario, the powering device 206 is a flexible film-based supercapacitor that may be coupled to the electronic chip 202 by sticking the powering device 206 on a designated portion of the transaction card 104. Beneficially, the GO based SC is capable of storing large amount of power and has a small recharge period. Further, the GO based SC exhibits a significant number of charge-discharge cycles that allows for long time use of the powering device 206. Additionally, the powering device 206 may be a rechargeable Graphene Polymer sheet SC.

In another embodiment, the powering device 206 is a rechargeable button battery that is coupled to the electronic chip 202 and the signal transmitter 204 via a circuitry that may be embedded within a portion of the transaction card 104. In another embodiment, the powering device 206 may be a rechargeable chip battery that may be coupled to the electronic chip 202 and the signal transmitter 204 via the embedded circuitry within the portion of the transaction card 104. In another embodiment, the powering device 206 may be a rechargeable solar cell coupled to the electronic chip 202 and the signal transmitter 204 via the embedded circuitry of the transaction card 104. The powering device 206 may be recharged by exposing the transaction card 104 or the powering device 206 to sunlight. It will be apparent to a person of ordinary skill in the art that other powering mechanism known in the art may be used to implement the powering device 206 without deviating from the scope of the disclosure.

It will be apparent to a person of ordinary skill in the art that the transaction card 104 in FIG. 2 is illustrated for exemplary purposes. Although, the transaction card 104 is shown to include fourteen input buttons 0-9, B_1, B_2, B_3, and B_4, the scope of the transaction card 104 is not limited it. For example, when the activation code is a motion gesture, the transaction card 104 may only include the input buttons B_1, B_2, B_3, and B_4. In another embodiment, the transaction card 104 may only include one input button B_1 that has multiple transactional data assigned thereto. For example, when the input button B_1 is pressed once within a defined time-period, the first electrical signal generated by the electronic chip 202 includes the encrypted PIN and when the input button B_1 is pressed twice within the defined time-period, the first electrical signal generated by the electronic chip 202 includes the encrypted card number. Likewise, when the input button B_1 is pressed thrice within the defined time-period, the first electrical signal generated by the electronic chip 202 includes the encrypted CVV and when the input button B_1 is pressed four times within the defined time-period, the first electrical signal generated by the electronic chip 202 includes the encrypted expiry date. In other words, a single input button may be assigned to multiple transactional data and may be capable of receiving different transactional inputs for different transactional data.

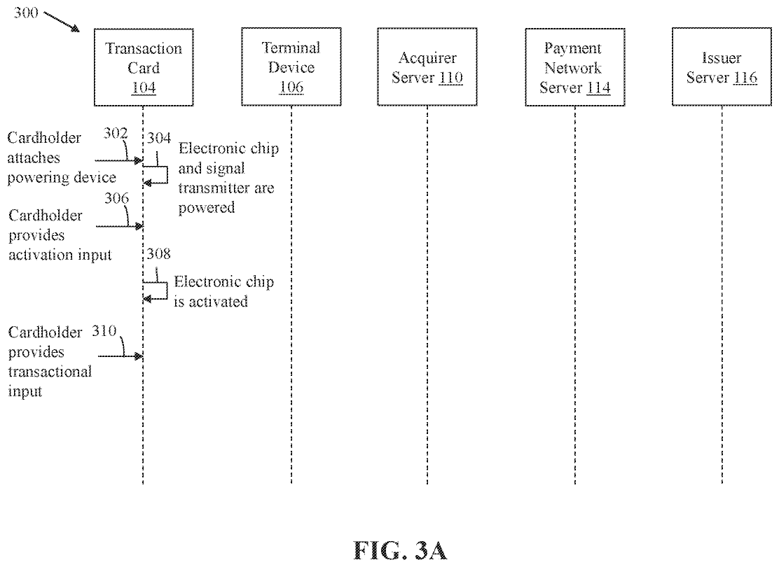

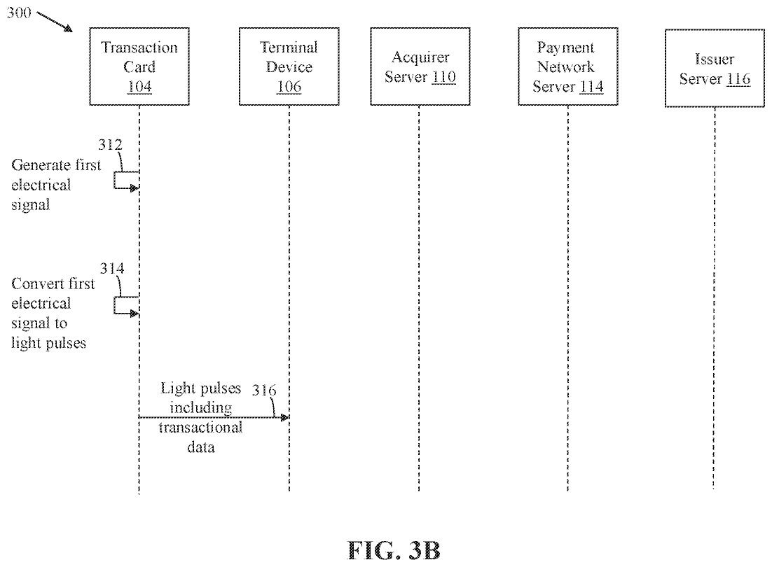

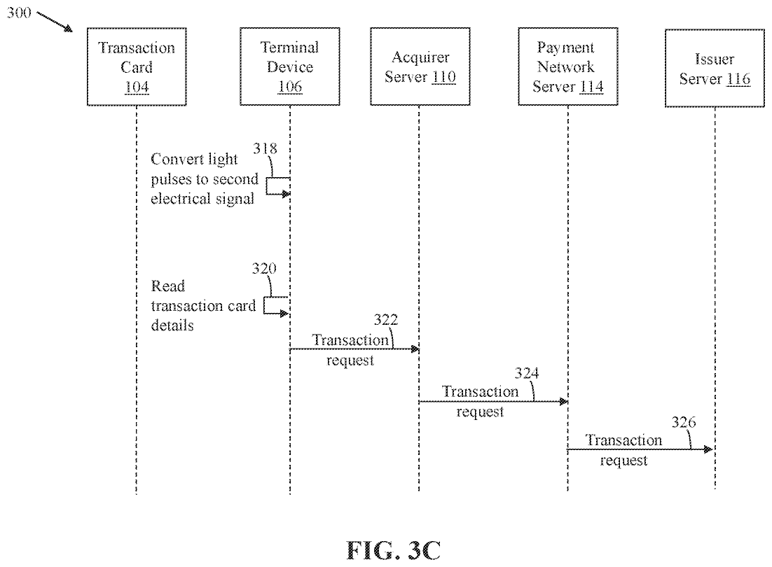

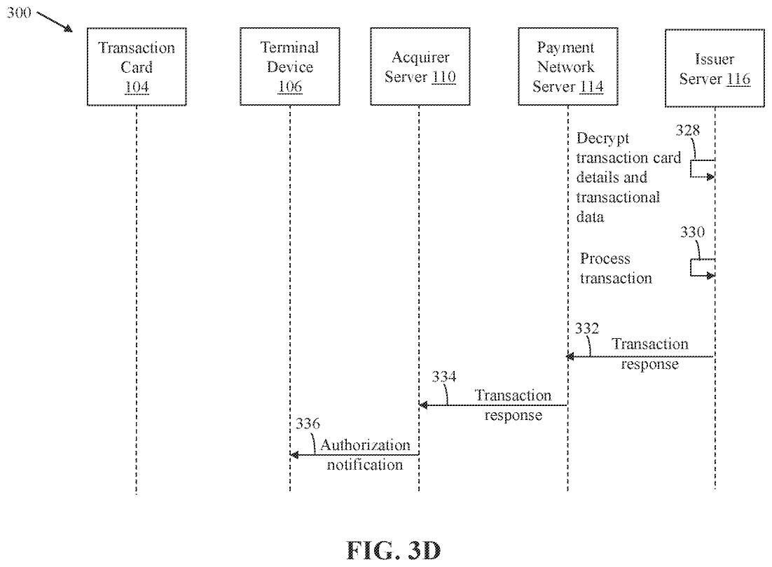

FIGS. 3A, 3B, 3C, and 3D, collectively represent a process flow diagram 300 that illustrates an exemplary scenario for facilitating a secure card-based transaction at the terminal device 106 using the transaction card 104, in accordance with an exemplary embodiment of the present disclosure. The process flow diagram 300 involves the transaction card 104, the terminal device 106, the acquirer server 110, the payment network server 114, and the issuer server 116.

The cardholder 102 may want to perform a secure transaction at the terminal device 106 using the transaction card 104. Prior to using the transaction card 104, the transaction card 104 is required to be powered up and activated. For powering the transaction card 104, the cardholder 102 attaches the powering device 206 to the transaction card 104 (as shown by arrow 302). For attaching the powering device 206 to the transaction card 104, the cardholder 102 aligns and connects the positive terminal of the powering device 206 with the positive terminal of the electronic chip 202, and aligns and connects the negative terminal of the powering device 206 with the negative terminal of the electronic chip 202. Upon attachment of the powering device 206, the electronic chip 202 and the signal transmitter 204 of the transaction card 104 are powered (as shown by arrow 304). It will be apparent to a person or ordinary skill in the art that powering of the electronic chip 202 and the signal transmitter 204 corresponds to powering the transaction card 104. Upon powering up, the electronic chip 202 and the signal transmitter 204 may be in a deactivated state by default.

The cardholder 102 then provides the activation input to the transaction card 104 (as shown by arrow 306). In one example, the cardholder 102 presses the input buttons 0, 1, 2, and 5 sequentially on the keypad 208 for providing the activation input. In another example, the cardholder 102 provides the activation input via the user device 108. The user device 108 may have an application running thereon that allows for activation and deactivation of the transaction card 104 (i.e., the electronic chip 202). In another example, the cardholder 102 makes the required motion gesture using the transaction card 104 for providing the activation input. The activation input provided by the cardholder 102 provides the activation code to the electronic chip 202, thus activating the electronic chip 202 (as shown by arrow 308). For example, pressing of the input buttons 0, 1, 2, and 5 sequentially on the keypad 208 provides the activation code ‘0125’ to the electronic chip 202 for activation. Activation of the electronic chip 202 makes the electronic chip 202 and the signal transmitter 204 operational. The cardholder 102 may then use the transaction card 104 at the terminal device 106 for initiating the transaction.

The cardholder 102 provides the first transactional input to the transaction card 104 for initiating the transaction at the terminal device 106 (as shown by arrow 310). The first transactional input may be provided by pressing the input button B_1 that is assigned to the PIN of the transaction card 104. Based on the pressing of the input button B_1, the electronic chip 202 of the transaction card 104 generates the first electrical signal (as shown by arrow 312). Since the cardholder 102 provided the first transactional input by pressing the input button B_1, the first electrical signal includes the encrypted PIN of the transaction card 104. The signal transmitter 204 of the transaction card 104 receives the first electrical signal generated by the electronic chip 202 and converts the first electrical signal to light pulses (as shown by arrow 314). The signal transmitter 204 then transmits the light pulses, including the encrypted PIN (i.e., the encrypted transactional data), to the terminal device 106 (as shown by arrow 316).

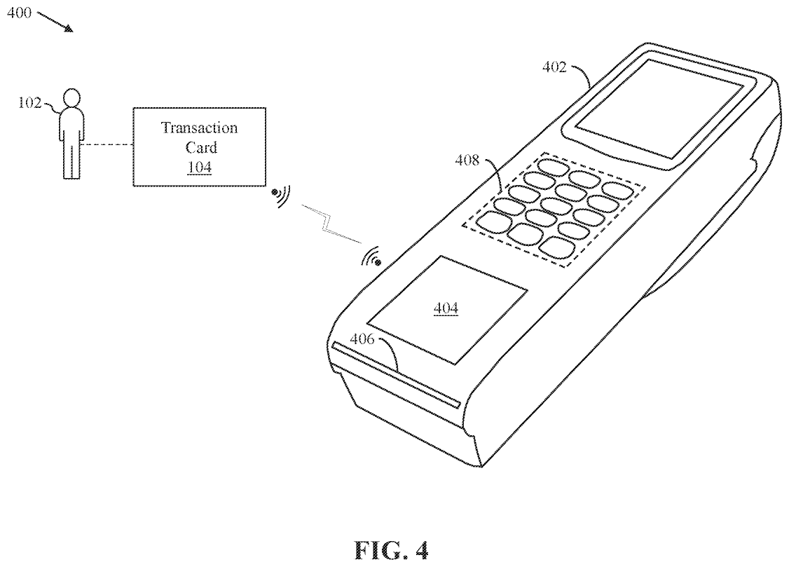

The terminal device 106 receives the light pulses transmitted by the signal transmitter 204 by way of a signal receiver (shown in FIG. 4) therein. The signal receiver of the terminal device 106 converts the received light pulses to a second electrical signal (as shown by arrow 318). The second electrical signal includes the encrypted PIN (i.e. the encrypted transactional data). The terminal device 106, via a transaction card reader therein (shown in FIG. 4), further reads the transaction card memory 200 to obtain the encrypted transaction card details of the transaction card 104 (as shown by arrow 320). The terminal device 106 then transmits a transaction request to the acquirer server 110 associated with the terminal device 106 (as shown by arrow 322). The transaction request includes the encrypted transaction card details and the second electrical signal. In other words, the terminal device 106, by way of the transaction request, communicates the encrypted transaction card details and the encrypted transactional data to the acquirer server 110 for processing the transaction.

The acquirer server 110 receives the transaction request from the terminal device 106. The acquirer server 110 in turn, identifies the payment network server 114 associated with the transaction card 104 and transmits the received transaction request to the identified payment network server 114 (as shown by arrow 324). The payment network server 114 then identifies the issuer server 116 associated with the transaction card 104 and transmits the received transaction request to the identified issuer server 116 (as shown by arrow 326).

The issuer server 116 receives the transaction request from the payment network server 114. The issuer server 116 owns a decryption key (namely, solution) for decrypting the encrypted transaction card details and the encrypted transactional data included in the transaction request. In one embodiment, the issuer server 116 may decrypt the encrypted transaction card details and the encrypted transactional data using a private key (as shown by arrow 328). For example, the decrypted transactional input (such as, the PIN) may serve as the private key for decrypting the encrypted transaction card details. Subsequently, the issuer server 116 processes the transaction (as shown by arrow 330). The issuer server 116 transmits a transaction response to the payment network server 114 (as shown by arrow 332). The transaction response indicates a result of transaction processing. For example, the result of the transaction processing may indicate whether the transaction is approved, declined, or pending. The payment network server 114 receives the transaction response and transmits the transaction response to the acquirer server 110 (as shown by arrow 334). When the transaction is approved, the acquirer server 110 transmits an authorization notification to the terminal device 106 (as shown by arrow 336). However, when the transaction is declined, the acquirer server 110 may transmit a decline notification instead of the authorization notification to the terminal device 106. The terminal device 106 receives the authorization notification. In a scenario where the terminal device 106 is an ATM and the transaction is performed for cash withdrawal, the terminal device 106 dispenses cash equivalent to an amount of the transaction.

FIG. 4 is a schematic diagram that illustrates an exemplary scenario 400 for conducting a secure card-based transaction using the transaction card 104 at the terminal device 106, in accordance with an exemplary embodiment of the present disclosure. A POS device 402 in FIG. 4 is an example of the terminal device 106.

The POS device 402 is a payment device that is used to process card payments at retail locations, such as a merchant store, a restaurant, or the like, for purchase of goods, services, or the like. The POS device 402 (i.e., the terminal device 106) comprises the signal receiver (hereinafter, designated to and referred as “the signal receiver 404”), the transaction card reader (hereinafter, designated to and referred as “the transaction card reader 406”), and buttons 408.

The signal receiver 404 is an electronic device configured to receive the light pulses transmitted by the signal transmitter 204 of the transaction card 104. Further, the signal receiver 404 is also configured to convert the received light pulses to the second electrical signal including the encrypted transactional data. The signal receiver 404 may include a transducer that is configured to convert the received light pulses to the second electrical signal.

In one example, the signal receiver 404 is an IR signal receiver configured to receive IR light pulses and convert the IR light pulses to the second electrical signal. In another example, the signal receiver 404 is an RF signal receiver that is configured to receive RF pulses and convert the RF pulses to the second electrical signal. In another example, the signal receiver 404 is an optical signal receiver that is configured to receive optical pulses and convert the optical pulses to the second electrical signal. In another example, the signal receiver 404 is a visible light signal receiver that is configured to receive visible light pulses and convert the visible light pulses to the second electrical signal.

The transaction card reader 406 is an electronic device that is configured to read the encrypted transaction card details stored in the transaction card memory 200 during a contact-based transaction or a contactless transaction. In one embodiment, the transaction card reader 406 reads the transaction card memory 200 when the transaction card 104 is inserted into or swiped at the transaction card reader 406. In another embodiment, the transaction card reader 406 reads the transaction card memory 200 when the transaction card 104 is tapped at the transaction card reader 406.

Buttons 408 of the POS device 402 are operable for manually providing additional transactional data, e.g., an amount of the transaction, required for processing the transaction.

In an implementation example, the cardholder 102 may want to make a transaction for a purchase payment using the transaction card 104. The cardholder 102 may be required to initiate the transaction at the POS device 402. For initiating the transaction at the POS device 402, the cardholder 102 attaches the powering device 206 to the transaction card 104. The attached powering device 206 powers the electronic chip 202 and the signal transmitter 204 of the transaction card 104. The cardholder 102 then activates the electronic chip 202 and the signal transmitter 204 by pressing the input buttons 0, 1, 2, and 5 (i.e., providing the activation input) on the keypad 208. The electronic chip 202 activates when the activation code corresponding to the provided activation input is correct. It will be apparent to a person of skill in the art that activation of the electronic chip 202 may also be referred to as activation of the transaction card 104.

The cardholder 102, upon activation of the transaction card 104, uses the transaction card 104 at the POS device 402. Contrary to providing the PIN by using the buttons 408 of the POS device 402, the cardholder 102 presses the input button B_1 (shown in FIG. 2) that is assigned to the PIN of the transaction card 104 and initiates the transaction at the POS device 402. Pressing of the input button B_1 does not reveal the actual PIN of the transaction card 104 to any bystander. Upon pressing of the input button B_1, the light pulses including the encrypted PIN (i.e., the encrypted transactional data) are communicated to the POS device 402 by the transaction card 104. Subsequently, the transaction card reader 406 reads the encrypted transaction card details stored in the transaction card memory 200. For example, the POS device 402 may read the transaction card details by way of a tap or a contact-based interaction with the transaction card 104. The POS device 402 is further configured to receive other transactional data, such as the amount of the transaction, provided via the buttons 408 of the POS device 402. Subsequently, the POS device 402 generates and communicates the transaction request including the encrypted transaction card details and the second electrical signal to the issuer server 116, via the acquirer server 110 and the payment network server 114, for processing the transaction. The issuer server 116 then processes the transaction and debits the amount from the financial account associated with the transaction card 104. The POS device 402 then presents the authorization notification to the cardholder 102.

In another implementation example, the terminal device 106 may be an ATM. In such a scenario, the ATM includes the signal receiver 404 and the transaction card reader 406. It will apparent to a person ordinary skill in the art that the cardholder 102 may perform a transaction at the ATM in a similar manner as described above for the POS device 402.

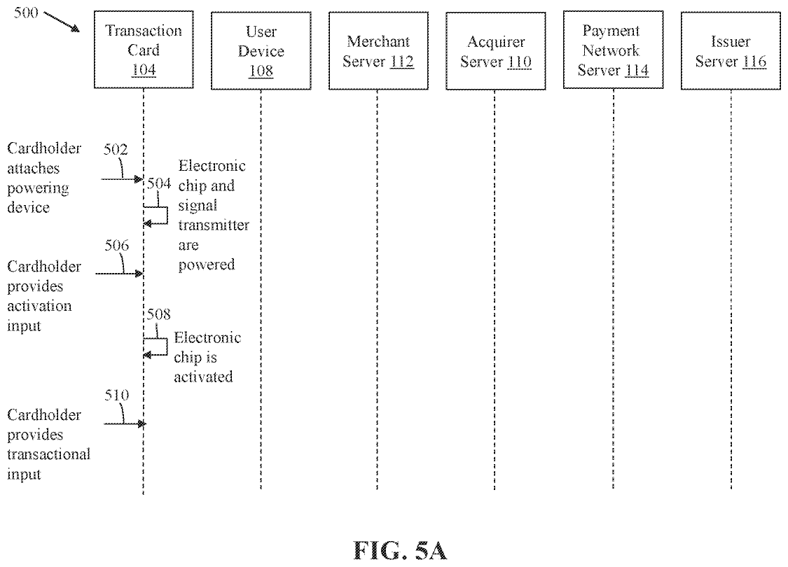

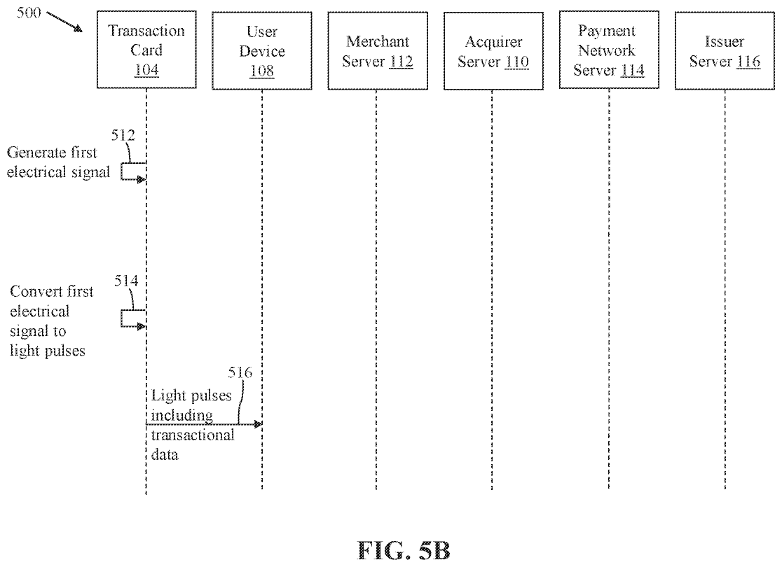

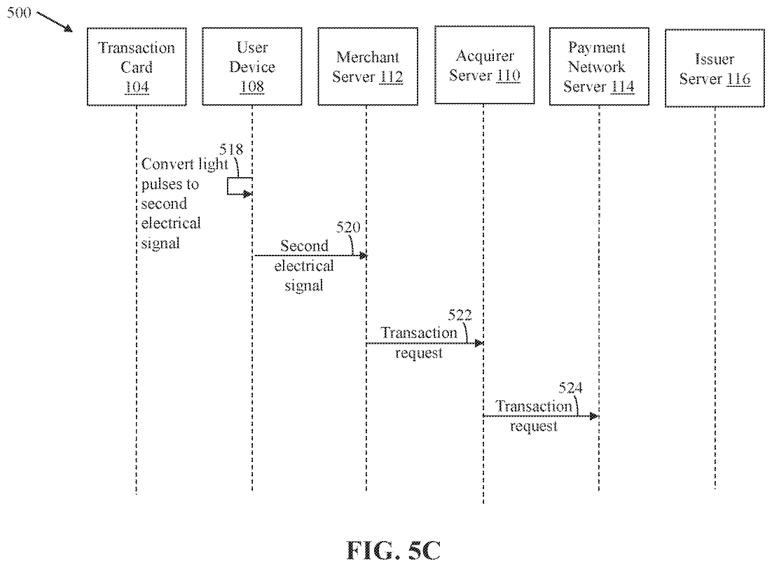

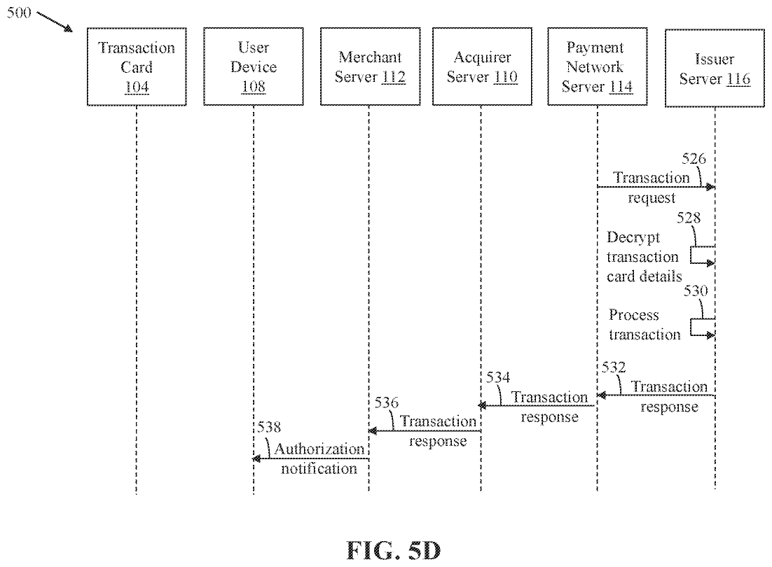

FIGS. 5A, 5B, 5C, and 5D, collectively represent a process flow diagram 500 that illustrates an exemplary scenario for facilitating a secure card-based transaction using the transaction card 104 at an e-commerce platform accessed on the user device 108, in accordance with an exemplary embodiment of the present disclosure. The process flow diagram 500 involves the transaction card 104, the user device 108, the acquirer server 110, the merchant server 112, the payment network server 114, and the issuer server 116.

The cardholder 102 may want to perform a secure online transaction using the transaction card 104 at the e-commerce platform accessed on the user device 108. Prior to using the transaction card 104, the transaction card 104 is required to be powered up and activated. For powering the transaction card 104, the cardholder 102 attaches the powering device 206 to the transaction card 104 (as shown by arrow 502). For attaching the powering device 206, the cardholder 102 aligns and connects the positive terminal of the powering device 206 with the positive terminal of the electronic chip 202, and aligns and connects the negative terminal of the powering device 206 with the negative terminal of the electronic chip 202. Upon attachment of the powering device 206, the electronic chip 202 and the signal transmitter 204 of the transaction card 104 are powered (as shown by arrow 504).

The cardholder 102 then provides the activation input to the transaction card 104 (as shown by arrow 506). Various examples in which the cardholder 102 provides the activation input to the transaction card 104 are described in foregoing description of FIGS. 3A-3D. The activation input provided by the cardholder 102 provides the activation code to the electronic chip 202, thus activating the electronic chip 202 (as shown by arrow 508). Activation of the electronic chip 202 makes the electronic chip 202 and the signal transmitter 204 operational.

In one embodiment, the transaction card 104 may be stored on file at the e-commerce platform and the cardholder 102 may select the transaction card 104 as a payment means for initiating the online transaction at the e-commerce platform. Based on the selection, the e-commerce platform prompts the cardholder 102 to provide the CVV and/or the PIN (i.e., the transactional data) of the stored transaction card 104. Based on prompting, the cardholder 102 provides the third transactional input (and/or the first transactional input) to the transaction card 104 (as shown by arrow 510). The third transactional input may be provided by pressing the input button B_3 that is assigned to the CVV of the transaction card 104.

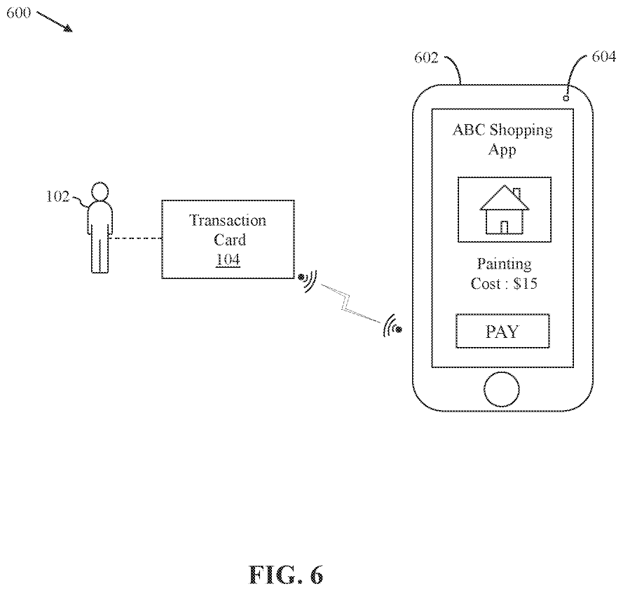

Based on the third transactional input provided by the cardholder 102, the electronic chip 202 generates the first electrical signal including the encrypted CVV (i.e., the encrypted transactional data) (as shown by arrow 512). The signal transmitter 204 receives the first electrical signal from the electronic chip 202 and converts the first electrical signal to light pulses (as shown by arrow 514). Further, the signal transmitter 204 of the transaction card 104 transmits the generated light pulses to a signal receiver (as shown in FIG. 6) of the user device 108 (as shown by arrow 516). The signal receiver of the user device 108 receives the light pulses and converts the received light pulses to a second electrical signal (as shown by arrow 518). The second electrical signal includes the encrypted transactional data, e.g., the encrypted CVV and/or the encrypted PIN.

The user device 108 then transmits the second electrical signal to the merchant server 112 of the e-commerce platform (as shown by arrow 520). The merchant server 112 receives the second electrical signal and communicates a transaction request to the acquirer server 110 (as shown by arrow 522). The transaction request includes the second electrical signal including the encrypted transactional data and the encrypted transaction card details of the transaction card 104. The acquirer server 110 identifies the payment network server 114 associated with the transaction card 104 and transmits the received transaction request to the identified payment network server 114 (as shown by arrow 524). Further, the payment network server 114 identifies the issuer server 116 associated with the transaction card 104 and transmits the received transaction request to the identified issuer server 116 (as shown by arrow 526). The issuer server 116 decrypts the encrypted transactional data (as shown by arrow 528) in the transaction request and processes the transaction (as shown by arrow 530). The issuer server 116 transmits the transaction response to the payment network server 114 (as shown by arrow 532). The transaction response includes a result of transaction processing. For example, the result of the transaction processing may indicate whether the transaction is approved, declined, or pending. The payment network server 114 transmits the transaction response to the acquirer server 110 (as shown by arrow 534). The acquirer server 110 transmits the transaction response to the merchant server 112 (as shown by arrow 536). When the transaction is approved, the merchant server 112 transmits an authorization notification (as shown by arrow 538) to the user device 108. However, when the transaction is declined, the merchant server 112 may transmit a transaction declined notification to the user device 108 instead of the authorization notification.

In another embodiment, the transaction card 104 may not be saved on file with the e-commerce platform. In such a scenario, the e-commerce platform may prompt the cardholder 102 through the user device 108 to provide the transaction card details (e.g., the card number and the expiry date) of the transaction card 104 along with the CVV and or the PIN (i.e., the transactional data) for initiating the transaction. Contrary to manually typing the card number and the expiry date on the user device 108, the cardholder 102 may further utilize the input buttons 0-9, B_1, B_2, B_3, and B_4 on the transaction card 104 for providing the transaction card details to the e-commerce platform. For example, the cardholder 102 may provide the second and fourth transactional inputs by pressing the input buttons B_2 and B_4. Since the input button B_2 is assigned to the card number of the transaction card 104, pressing of the input button B_2 causes the activated electronic chip 202 to generate the first electrical signal including the encrypted card number. The signal transmitter 204 then converts the first electrical signal to light pulses and communicates the light pulses to the signal receiver of the user device 108. Likewise pressing of the input button B_4, assigned to the expiry date of the transaction card 104, causes the activated electronic chip 202 to generate the first electrical signal including the encrypted expiry date. The signal transmitter 204 then converts the first electrical signal to light pulses and communicates the light pulses to the signal receiver of the user device 108. The signal receiver of the user device 108 then converts the light pulses including the encrypted card number and the encrypted expiry date to the second electrical signal. The user device 108 then communicates the second electrical signal including the encrypted card number and the encrypted expiry date along with the encrypted CVV and/or the encrypted PIN to the merchant server 112 for transaction processing.

FIG. 6 is a schematic diagram that illustrates an exemplary scenario 600 for conducting a card-based transaction using the transaction card 104 at an e-commerce platform accessed through the user device 108, in accordance with an exemplary embodiment of the present disclosure. A smartphone 602 in FIG. 6 is an example of the user device 108. The smartphone 602 comprises the signal receiver (hereinafter, designated and referred to as “the signal receiver 604”).

The signal receiver 604 is an electronic device that is configured to receive the light pulses transmitted by the signal transmitter 204. The signal receiver 604 is further configured to convert the received light pulses to the second electrical signal including the encrypted transactional data. In an example, the signal receiver 604 may be an IR signal receiver. In another example, the signal receiver 604 may be an RF signal receiver. In another example, the signal receiver 604 may be an optical signal receiver. In another example, the signal receiver 604 may be a visible light receiver.

In an implementation example, the cardholder 102 accesses ABC Shopping App (i.e., the e-commerce platform) on the smartphone 602. The cardholder 102 selects, for purchasing, “a painting” being sold on the ABC Shopping App for $15. The cardholder 102 further selects the transaction card 104 for performing a transaction to purchase “the painting”. In one embodiment, the transaction card 104 may already be stored on file with the ABC Shopping App. The ABC Shopping App then prompts the cardholder 102 through the smartphone 602 to provide the transactional data (e.g., the CVV or the PIN) of the transaction card 104 for the transaction.

The cardholder 102 attaches the powering device 206 to the transaction card 104. The attached powering device 206 powers the electronic chip 202 and the signal transmitter 204. The cardholder 102 then activates the transaction card 104 by pressing the input buttons 0, 1, 2, and 5 (i.e., providing the activation input) on the keypad 208. The electronic chip 202 activates when the activation code corresponding to the provided activation input is correct. The cardholder 102 further activates the signal receiver 604 of the smartphone 602.

The cardholder 102 then operates the input buttons 0-9, B_1, B_2, B_3, and B_4 corresponding to the required transactional data. For example, when the required transactional data is the CVV of the transaction card 104, the cardholder 102 presses the input button B_3 (i.e., provides the third transactional input) assigned to the CVV. Upon pressing of the input button B_3, the light pulses including the encrypted CVV (i.e., the encrypted transactional data) are communicated to the signal receiver 604 of the smartphone 602 by the signal transmitter 204. The signal transmitter 204 may transmit the light pulses wirelessly, for example, as an IR signal, a RF signal, or visible light pulses. The smartphone 602 then communicates the encrypted CVV to the merchant server 112 in the form of the second electrical signal. The merchant server 112 then communicates the transaction request including the stored transaction card details and the second electrical signal to the issuer server 116, via the acquirer server 110 and the payment network server 114, for processing the transaction. The issuer server 116 then processes the transaction and debits $15 from the financial account associated with the transaction card 104. The smartphone 602 then presents the authorization notification to the cardholder 102.

In another embodiment, the transaction card 104 may not be saved on file with the ABC Shopping App. In such a scenario, the ABC Shopping App may prompt the cardholder 102 through the smartphone 602 to provide the card number and the expiry date of the transaction card 104 along with the transactional data for initiating the transaction. Contrary to manually typing the card number and the expiry date on the smartphone 602, the cardholder 102 presses the input buttons B_2 and B_4 assigned to the card number and the expiry date, respectively, for providing the encrypted card number and expiry date to the ABC shopping App. When the input button B_2 is pressed, the activated electronic chip 202 generates the first electrical signal including the encrypted card number. The signal transmitter 204 then converts the received first electrical signal to light pulses and communicates it to the signal receiver 604. The signal receiver 604 then converts the received light pulses to an electrical signal and communicates the electrical signal including the encrypted card number to the merchant server 112. Similarly, when the input button B_4 is pressed, the activated electronic chip 202 generates the first electrical signal including the encrypted expiry date. The signal transmitter 204 then converts the received first electrical signal to light pulses and communicates it to the signal receiver 604. The signal receiver 604 then converts the received light pulses to an electrical signal and communicates the electrical signal including the encrypted expiry date to the merchant server 112. The merchant server 112 may then include the received transaction card details in the transaction request along with the transactional data for processing the transaction.

Since the cardholder 102 is not required to manually type the card number and the expiry date on the smartphone 602, a malicious software running in background on the smartphone 602 is unable to intercept the card number and the expiry date. Thus, the transaction card 104 solves the technical problem of data security in the domain of transaction processing.

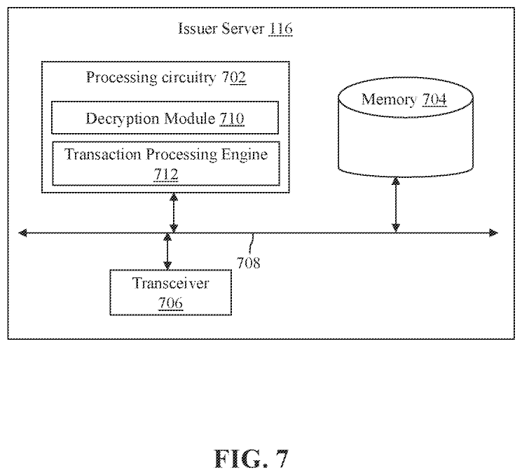

FIG. 7 is a block diagram that illustrates the issuer server 116, in accordance with an exemplary embodiment of the present disclosure. The issuer server 116 may include processing circuitry 702, a memory 704, and a transceiver 706. The processing circuitry 702, the memory 704, and the transceiver 706 may communicate with each other by way of a communication bus 708. The processing circuitry 702 may include a decryption engine 710 and a transaction processing engine 712.

The processing circuitry 702 includes suitable logic, circuitry, interfaces, and/or code, executed by the circuitry, for processing the transactions performed by way of the transaction card 104. Examples of the processing circuitry 702 may include, but are not limited to, an application-specific integrated circuit (ASIC) processor, a reduced instruction set computer (RISC) processor, a complex instruction set computer (CISC) processor, a field programmable gate array (FPGA), and the like. The processing circuitry 702 may execute various transaction processing operations by way of the decryption engine 710 and the transaction processing engine 712.

The memory 704 includes suitable logic, circuitry, interfaces, and/or code, executable by the circuitry, to store various instructions for processing the transactions. Examples of the memory 704 may include a random-access memory (RAM), a read-only memory (ROM), a removable storage drive, a hard disk drive (HDD), a flash memory, a solid-state memory, and the like. It will be apparent to a person skilled in the art that the scope of the disclosure is not limited to realizing the memory 704 in the issuer server 116, as described herein. In another embodiment, the memory 704 may be realized in form of a database server or a cloud storage working in conjunction with the acquirer server 110, without departing from the scope of the disclosure.

The decryption engine 710 is configured to decrypt the encrypted transaction card details and the encrypted transactional data included in the received transaction request. The decryption engine 710 may use a decryption technique known in the art for decrypting the encrypted transaction card details and the encrypted transactional data.

The transaction processing engine 712 may process the transaction based on the transaction request received by the issuer server 116. The transaction processing engine 712 may process the transaction (e.g., authorize or decline the transactions) and communicate the transaction response to the payment network server 114. For example, the transaction processing engine 712 may determine whether the financial account linked to the transaction card 104 has sufficient funds to cover the amount of the transaction. In one example, the transaction processing engine 712 may determine that the financial account has sufficient funds to cover the amount of the transaction and authorizes the transaction. In another example, the transaction processing engine 712 may determine that the financial account does not have sufficient funds to cover the amount of the transaction, and decline the transaction.

The transceiver 706 may include suitable logic, circuitry, interfaces, and/or code, executable by the circuitry, to transmit and receive data over the communication network 118 using one or more communication network protocols. The transceiver 706 may transmit requests and messages to and receive requests and messages from the payment network server 114. Examples of the transceiver 706 may include, but are not limited to, an antenna, a radio frequency transceiver, a wireless transceiver, a Bluetooth transceiver, an ethernet port, a universal serial bus (USB) port, or any other device configured to transmit and receive data.

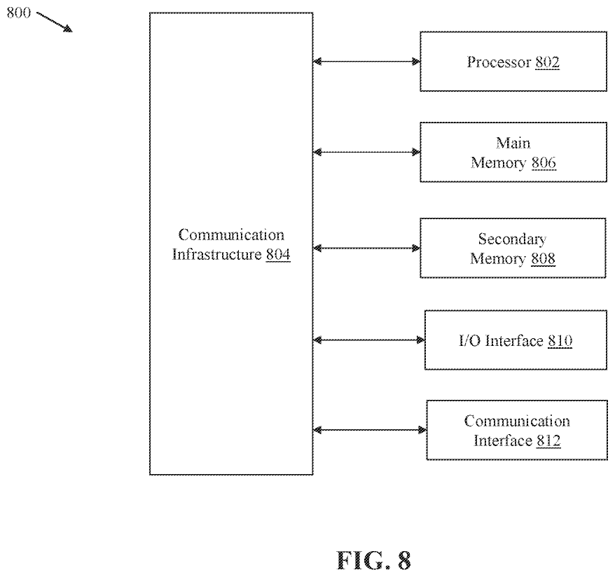

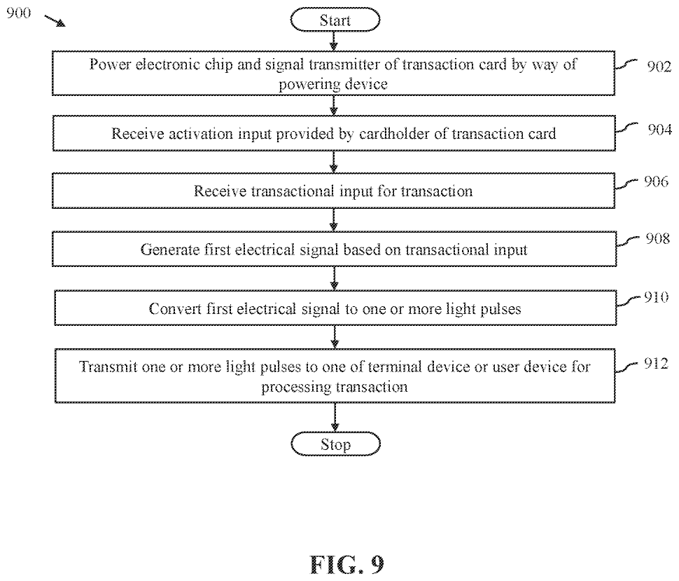

FIG. 8 is a block diagram that illustrates a system architecture of a computer system 800, in accordance with an embodiment of the present disclosure. An embodiment of present disclosure, or portions thereof, may be implemented as computer readable code on the computer system 800. In one example, the terminal device 106, the user device 108, the acquirer server 110, the merchant server 112, the payment network server 114, and the issuer server 116 of FIG. 1 may be implemented as the computer system 800. Hardware, software, or any combination thereof may embody modules and components used to implement the methods of FIGS. 9, 10, 11, and 12.

The computer system 800 includes a processor 802 that may be a special-purpose or a general-purpose processing device. The processor 802 may be a single processor, multiple processors, or combinations thereof. The processor 802 may have one or more processor cores. In one example, the processor 802 is an octa-core processor. Further, the processor 802 may be connected to a communication infrastructure 804, such as a bus, message queue, multi-core message-passing scheme, and the like. The computer system 800 may further include a main memory 806 and a secondary memory 808. Examples of the main memory 806 may include RAM, ROM, and the like. The secondary memory 808 may include a hard disk drive or a removable storage drive, such as a floppy disk drive, a magnetic tape drive, a compact disc, an optical disk drive, a flash memory, and the like.

The computer system 800 further includes an input/output (I/O) interface 810 and a communication interface 812. The I/O interface 810 includes various input and output devices that are configured to communicate with the processor 802. Examples of the input devices may include a keyboard, a mouse, a joystick, a touchscreen, a microphone, and the like. Examples of the output devices may include a display screen, a speaker, headphones, and the like. The communication interface 812 may be configured to allow data to be transferred between the computer system 800 and various devices that are communicatively coupled to the computer system 800. Examples of the communication interface 812 may include a modem, a network interface, i.e., an Ethernet card, a communication port, and the like. Data transferred via the communication interface 812 may correspond to signals, such as electronic, electromagnetic, optical, or other signals as will be apparent to a person skilled in the art.

FIG. 9 is a flow chart 900 that illustrates a method for facilitating a secure card-based transaction using the transaction card 104, in accordance with an exemplary embodiment of the present disclosure.

At step 902, the electronic chip 202 and the signal transmitter 204 of the transaction card 104 are powered by way of the powering device 206. The powering device 206 is attached to the transaction card 104 for powering the electronic chip 202 and the signal transmitter 204. For attachment, the positive terminal of the powering device 206 is aligned with and connected to the positive terminal of the electronic chip 202 and the negative terminal of the powering device 206 is aligned with and connected to the negative terminal of the electronic chip 202.

At step 904, the activation input, provided by the cardholder 102, is received by the transaction card 104. The cardholder 102 provides the activation input via the input buttons 0-9, B_1, B_2, B_3, and B_4 of the transaction card 104. The activation input provides the activation code to the electronic chip 202, and thus activates the electronic chip 202 and the signal transmitter 204. In other words, upon receiving the activation input, the electronic chip 202 and the signal transmitter 204 become operational.

At step 906, the transactional input, provided by the cardholder 102, is received via the input buttons 0-9, B_1, B_2, B_3, and B_4. For example, the cardholder 102 presses one or more input buttons from the input buttons 0-9, B_1, B_2, B_3, and B_4. At step 908, the electronic chip 202 receives the transactional input and generates the first electrical signal based on the transactional input. The first electrical signal includes the encrypted transactional data of the transaction card 104 corresponding to the transactional input.

At step 910, the signal transmitter 204 converts the first electrical signal received from the electronic chip 202 to one or more light pulses. At step 912, the signal transmitter 204 transmits the one or more light pulses to one of the terminal device 106 or the user device 108 for processing the transaction.

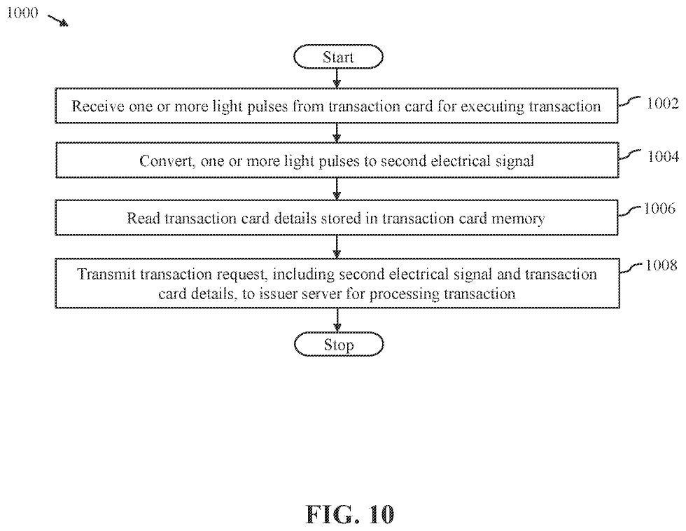

FIG. 10 is a flow chart 1000 that illustrates a method for facilitating a secure card-based transaction at the terminal device 106, in accordance with an exemplary embodiment of the present disclosure. At step 1002, the signal receiver 404 of the terminal device 106 receives the one or more light pulses from the signal transmitter 204 of the transaction card 104. The one or more light pulses include the encrypted transactional data (such as PIN). At step 1004, the signal receiver 404 converts the one or more light pulses to the second electrical signal including the encrypted transactional data. At step 1006, the terminal device 106, via the transaction card reader 406, reads the encrypted transaction card details stored in the transaction card memory 200. At step 1008, the terminal device 106 transmits the transaction request to the acquirer server 110. The transaction request includes the second electrical signal and the encrypted transaction card details. The acquirer server 110 transmits the transaction request to the payment network server 114. The payment network server 114 communicates the transaction request to the issuer server 116 for processing the transaction.

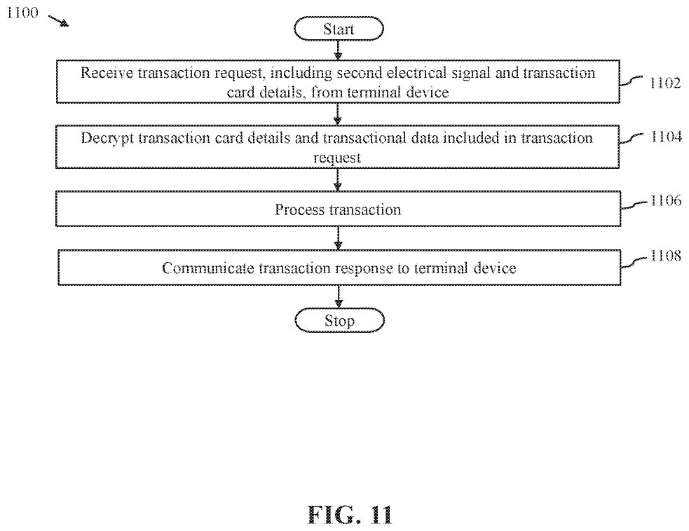

FIG. 11 is a flow chart 1100 that illustrates a method for facilitating a secure card-based transaction by the issuer server 116, in accordance with an exemplary embodiment of the present disclosure. At step 1102, the issuer server 116 receives the transaction request including the second electrical signal and the encrypted transaction card details. The transaction request is transmitted by the terminal device 106 to the issuer server 116 via the acquirer server 110 and the payment network server 114. At step 1104, the decryption engine 710 decrypts the encrypted transaction card details and the encrypted transactional data included in the second electrical signal. At step 1106, the issuer server 116 processes the transaction by updating the financial account associated with the transaction card 104. The issuer server 116 updates the financial account by debiting or crediting the financial account. At step 1108, the issuer server 116 communicates the transaction response to the payment network server 114. The payment network server 114 transmits the transaction response to the acquirer server 110. The acquirer server 110 transmits the transaction response to the terminal device 106. The transaction response may include any one of the authorization notification or the transaction decline notification based upon processing of the transaction by the issuer server 116.

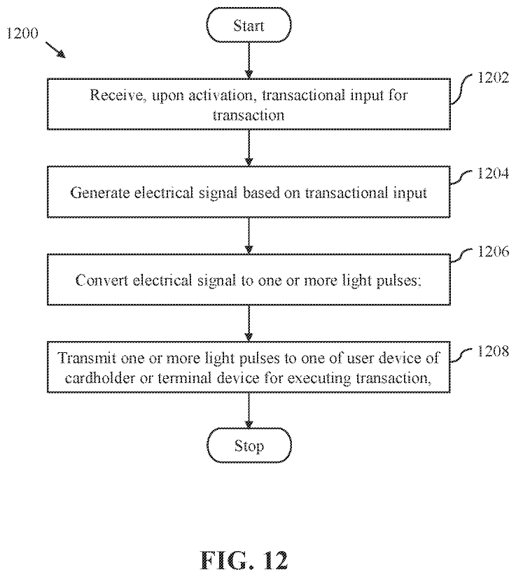

FIG. 12 is a high-level flow chart 1200 that illustrates a method for facilitating a secure card-based transaction, in accordance with an exemplary embodiment of the present disclosure. At step 1202, the electronic chip 202 of the transaction card 104, upon activation, receives a transactional input provided by the cardholder 102 of the transaction card 104 for the transaction. The input buttons 0-9, B_1, B_2, B_3, and B_4 on the transaction card 104 are used for providing the transactional input. At step 1204, the electronic chip 202 generates an electrical signal (e.g., the first electrical signal) based on the transactional input. The electrical signal includes encrypted transactional data associated with the transaction card 104. At step 1206, the signal transmitter 204 of the transaction card 104 converts the electrical signal to one or more light pulses. At step 1208, the signal transmitter 204 transmits the one or more light pulses to one of the user device 108 of the cardholder 102 or the terminal device 106 for executing the transaction. The transaction is processed by the issuer of the transaction card 104 based on the encrypted transactional data included in the one or more light pulses.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into digitally any device. Further, the operations may be described as a sequential process, however some of the operations may in fact be performed in parallel, concurrently, and/or in a distributed environment by single or multiprocessor machines. In addition, in some embodiments the order of operations may be rearranged without departing from the spirit of the disclosed subject matter.

The transaction card, method, and system disclosed herein facilitate secure transactions by preventing compromise of the transaction card details and transactional data. The transaction card 104 does not have the transaction card details (e.g., the card number, the CVV, and the expiry date) printed thereon. Therefore, a person, who is not the cardholder, is unable to obtain the transaction card details by merely looking at the transaction card 104. Further, the transaction card details or the transactional data can't be transmitted when the cardholder 102 accidently operates any of the input buttons 0-9, B_1, B_2, B_3, and B_4 as the electronic chip 202 and the signal transmitter 204 of the transaction card 104 need to be powered on for data transmission. The requirement of the activation input, prior to initiation of the transaction, also reduces likelihood of human error and unintentional data transmission.

Technical improvements in the transaction card 104 and the terminal device 106 have eliminated the requirement to input the transactional data to the terminal device 106 by manually operating the buttons of the terminal device 106. The cardholder 102 is not required to remember the transactional data (e.g., the PIN) as the encrypted transactional data is provided to the terminal device 106 by merely pressing a single input button B_1 on the transaction card 104. Therefore, a bystander is unable to obtain the transactional data (i.e., the PIN) by observing the cardholder's actions or using a cloning or skimming device. Further, the first electrical signal including the encrypted transactional data is only generated when the cardholder 102 provides a transactional input by pressing the input buttons 0-9, B_1, B_2, B_3, and B_4 on the transaction card 104. Thus, when no input button is pressed, the transactional data is unavailable for skimming. Further, the technical improvements in the transaction card 104 have eliminated the requirement to manually enter the transaction card details and the transactional data on the user device 108 for performing an e-commerce transaction. Thus, the transaction card details and the transactional data are secured from interception in unencrypted format by any malicious software running on the user device 108. Moreover, the encrypted transactional data is transmitted from the transaction card 104 to the terminal device 106 or the user device 108 in form of light pulses, thus, making the transaction process seamless and less time consuming. Since the transaction card, method, and system disclosed herein enhance data security of transaction processing systems, a count of card compromise complaints and fraudulent transaction disputes may be reduced. Reduction in the count of card compromise complaints and fraudulent transaction disputes reduces the transaction processing overhead and benefits for the parties (such as issuers, acquirers, and payment network interchanges) involved in transaction processing.

Techniques consistent with the present disclosure provide, among other features, systems and methods for facilitating secure card-based transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope. In the claims, the words ‘comprising’, ‘including’ and ‘having’ do not exclude the presence of other elements or steps then those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various embodiments of the present disclosure have been illustrated and described, it will be clear that the present disclosure is not limited to these embodiments only. Numerous modifications, changes, variations, substitutions, and equivalents will be apparent to those skilled in the art, without departing from the spirit and scope of the present disclosure, as described in the claims.

We claim:

1. A transaction card for facilitating secure card-based transactions, the transaction card comprising:
at least one input button for receiving a transactional input provided by a cardholder of the transaction card for initiating a transaction;
an electronic chip that is coupled to the input button and configured to generate, upon activation, an electrical signal based on the transactional input, wherein the electrical signal includes encrypted transactional data associated with the transaction card; and
a signal transmitter that is coupled to the electronic chip and configured to:
receive the electrical signal from the electronic chip;
convert the electrical signal to one or more light pulses; and
transmit the one or more light pulses to one of a terminal device or a user device for executing the transaction, wherein the transaction is processed by an issuer of the transaction card based on the encrypted transactional data included in the one or more light pulses.

2. The transaction card of claim 1, further comprising:
a powering device configured to power the electronic chip and the signal transmitter; and
a transaction card memory configured to store, in an encrypted format, one or more transaction card details of the transaction card.

3. The transaction card of claim 2, wherein the one or more transaction card details stored in the transaction card memory are readable by the terminal device when the transaction card is used at the terminal device.

4. The transaction card of claim 2, wherein the powering device is detachably coupled to the electronic chip.

5. The transaction card of claim 2, wherein the powering device is a rechargeable Graphene Oxide based supercapacitor.

6. The transaction card of claim 1, wherein the signal transmitter is an infrared signal transmitter and the one or more light pulses are one or more infrared light pulses.

7. The transaction card of claim 1, wherein the electronic chip is further configured to receive an activation input provided by the cardholder of the transaction card, and wherein based on the activation input the electronic chip is activated.

8. A method for facilitating secure card-based transactions, the method comprising:
receiving, by an electronic chip of a transaction card, upon activation, a transactional input provided by a cardholder of the transaction card for initiating a transaction, wherein at least one input button on the transaction card is used for providing the transactional input;
generating, by the electronic chip, an electrical signal based on the transactional input, wherein the electrical signal includes encrypted transactional data associated with the transaction card;
converting, by a signal transmitter of the transaction card, the electrical signal to one or more light pulses; and
transmitting, by the signal transmitter, the one or more light pulses to one of a user device of the cardholder or a terminal device for executing the transaction, wherein the transaction is processed by an issuer of the transaction card based on the encrypted transactional data included in the one or more light pulses.

9. The method of claim 8, further comprising powering, by a powering device of the transaction card, the electronic chip and the signal transmitter of the transaction card.

10. The method of claim 9, wherein the powering device is detachably coupled to the electronic chip.

11. The method of claim 9, wherein the powering device is a rechargeable Graphene Oxide based supercapacitor.

12. The method of claim 8, wherein the signal transmitter is an infrared signal transmitter and the one or more light pulses are one or more infrared light pulses, and wherein one or more transaction card details stored in a transaction card memory of the transaction card are read by the terminal device when the transaction card is used at the terminal device.

13. The method of claim 8, further comprising, receiving, by the electronic chip, an activation input provided by the cardholder of the transaction card, wherein based on the activation input the electronic chip is activated for initiating the transaction.

14. A system for facilitating secure card-based transactions, the system comprising:
a transaction card, comprising:
at least one input button for receiving a transactional input provided by a cardholder of the transaction card for initiating a transaction;
an electronic chip that is coupled to the input button and configured to generate, upon activation, a first electrical signal based on the transactional input, wherein the first electrical signal includes encrypted transactional data associated with the transaction card; and
a signal transmitter that is coupled to the electronic chip and configured to:
receive the first electrical signal from the electronic chip, and
convert the first electrical signal to one or more light pulses; and
a terminal device configured to:
receive the one or more light pulses from the transaction card,
convert the one or more light pulses to a second electrical signal that includes the encrypted transactional data required for processing the transaction, wherein the transaction is processed based on the encrypted transactional data.

15. The system of claim 14, further comprising a server arrangement configured to:
receive the second electrical signal from the terminal device, and
process the transaction based on the second electrical signal.

16. The system of claim 14, wherein the transaction card further comprises:
a powering device that is detachably coupled to the electronic chip and configured to power the electronic chip and the signal transmitter; and
a transaction card memory configured to store one or more transaction card details of the transaction card in an encrypted format, wherein the terminal device is further configured to read the one or more transaction card details from the transaction card memory when the transaction card is used at the terminal device.

17. The system of claim 16, wherein the powering device is a rechargeable Graphene Oxide based supercapacitor.

18. The system of claim 14, wherein the signal transmitter is an infrared signal transmitter and the one or more light pulses are one or more infrared light pulses.

19. The system of claim 14, wherein the electronic chip is further configured to receive an activation input provided by the cardholder of the transaction card, wherein based on the activation input the electronic chip is activated.

20. The system of claim 14, wherein the terminal device comprises a signal receiver that receives the one or more light pulses from the signal transmitter and converts the one or more light pulses to the second electrical signal.
